(19) United States
(12) Patent Application Publication
(10) Pub. No.: US 2013/0225702 A1
(43) Pub. Date: Aug. 29, 2013

(54) Recycled construction material made from fire-resistant styrofoam waste and method for preparing same

(71) Applicant: Dongkook Jang, Yangsan-si (KR)

(72) Inventor: Dongkook Jang, Yangsan-si (KR)

(21) Appl. No.: 13/884,633

(22) PCT Filed: Oct. 28, 2011
(86) PCT No.: PCT/KR2011/008135

§ 371 Date: May 10, 2013

(30) Foreign Application Priority Data
Nov. 12, 2010 (KR) 10-2010-0112828
Oct. 28, 2011 (KR) PCT/KR2011/008135

(51) Int. Cl. C08J 11/06

(52) U.S. Cl. CPC C08J 11/06
USPC 521/47; 521/55

(57) ABSTRACT

The present invention relates to construction material obtained by recycling fire-resistant Styrofoam waste, and to a method for preparing same. The present invention relates to recycled construction material made from fire-resistant Styrofoam waste, which is prepared by: mixing water, liquid soap, and a mixture consisting of 2 to 8 wt % of fire-resistant Styrofoam waste, 50 to 70 wt % of cement, 20 to 30 wt % of steel sludge, and 5 to 10 wt % of pearlite; and injection-molding or compression-molding the resultant mixture.

### CROSS-REFERENCE TO RELATED APPLICATION

This application claims the benefit of Korean Patent Application No. 10-2010-0112828, filed on Nov. 12, 2010 in the Korean Intellectual Property Office, the disclosure of which is incorporated herein by reference.

### TECHNICAL FIELD

The present invention relates to a recycled construction material made from a fire-resistant Styrofoam waste, and a method for preparing the same.

### BACKGROUND ART

In compliance with the fire defense law which regulates the forced guidelines on fire defenses, a new constructing building is strictly managed and supervised on the uses of fire resistant materials. In particular, most of prefabrication buildings have features in that a Styrofoam panel mainly occupying the portions except for a steel frame is substituted with a product combined with an inflammable Styrofoam panel and a tinplate. The conventional waste Styrofoam is generally recycled in various fashions such as an ingot and a fiber coating agent, etc. in melting and dissolution methods; however such recycles are limited to a disposable recycling circulation period. The inflammable Styrofoam which is competitively developed and marked is judged to be non-recyclable by conventional fashions due to the properties of inflammations, and no recycling fashions are developed.

### DISCLOSURE OF INVENTION

Accordingly, it is an object of the present invention to provide a recycled construction material made from a fire-resistant Styrofoam waste, and a method for preparing the same which make it possible to achieve a circulating resource by recycling semi-permanently an inflammable Styrofoam waste in the form of paper and combining various natures of the waste, by means of which the products recycled with various building materials come to enhance significantly the existing material performances for thereby enhancing the durability and safety of the buildings.

To achieve the above objects, there is provided a recycled construction material made from a fire-resistant Styrofoam waste, which is made in such a way that a mixture consisting of 2 to 8 wt % of a fine powder of a fire-resistant Styrofoam waste, 50 to 70 wt % of cement, 20 to 30 wt % of a steel sludge, and 5 to 10 wt % of pearlite, a liquid soap and water are mixed, and the thusly prepared mixture is injection-molded or compression-molded.

In addition, the present invention provided a recycled construction material made from a fire-resistant Styrofoam waste, which is made in such a way that a mixture consisting of 2 to 8 wt % of a fine powder of a fire-resistant Styrofoam waste, 50 to 70 wt % of cement, 20 to 30 wt % of a slated lime, and 5 to 10 wt % of pearlite, a liquid soap and water are mixed, and the thusly prepared mixture is injection-molded or compression-molded.

The present invention provides a recycled construction material made from a fire-resistant Styrofoam waste, which is made in such a way that a mixture consisting of 60 to 80 wt % of a fine powder of a fire-resistant Styrofoam waste, 10 to 20 wt % of a steel sludge, and 10 to 20 wt % of pearlite and a fire-resistant adhesive are added and mixed, and the mixed compound are injection-molded or compression-molded in a board shape.

In addition, the present invention provides a method for preparing a recycled construction material made from a fire-resistant Styrofoam waste, comprising crushing a fire-resistant Styrofoam waste into a fine powder; mixing the fine powder with at least one of cement, steel sludge, and pearlite; preparing a compound consisting of the thusly mixed mixture and a liquid soap and water; and preparing a formulated material by molding the compound.

In addition, the present invention provides a method for preparing a recycled construction material made from a fire-resistant Styrofoam waste, comprising crushing a fire-resistant Styrofoam waste bonded with cement or concrete into a fine powder; mixing the fine powder with at least one among cement, steel sludge, slated lime, and pearlite; preparing a compound consisting of the thusly mixed mixture and a liquid soap and water; and preparing a formulated material by molding the compound.

In addition, the present invention provides a method for preparing a recycled construction material made from a fire-resistant Styrofoam waste, comprising crushing a fire-resistant Styrofoam waste into a fine powder; mixing the fine powder with at least one of with cement, steel slurry, slated lime, and pearlite; and preparing a non-formulated construction material by mixing the thusly mixed mixture with a liquid soap and water.

### ADVANTAGEOUS EFFECTS

The recycled construction material made from a fire-resistant Styrofoam waste, and a method for preparing the same according to the present invention are advantageous to reduce the public sector costs which occur due to the productions of the wastes.

In addition, the recycled construction material made from a fire-resistant Styrofoam waste, and a method for preparing the same according to the present invention can serve to enhance the durability and safety of the buildings.

### BRIEF DESCRIPTION OF DRAWINGS

FIG. 1 is a flow chart of a method for preparing a recycled construction material made from a fire-resistant Styrofoam waste according to an embodiment of the present invention.

### BEST MODES FOR CARRYING OUT THE INVENTION

The inventions will be described in more details with reference to the accompanying drawings.

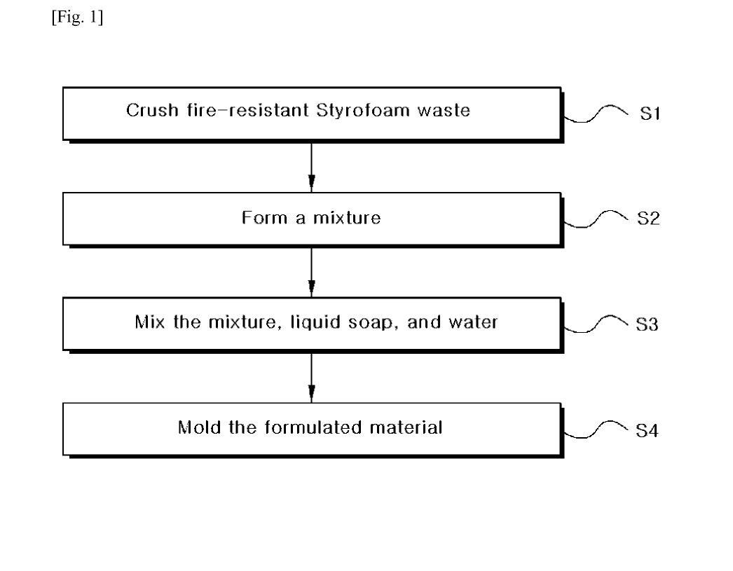

FIG. 1 is a flow chart of a method for preparing a recycled construction material made from a fire-resistant Styrofoam waste according to an embodiment of the present invention. First of all, fire-resistant Styrofoam waste is crushed to fine powder with a diameter of below 2 mm (S1). The crushed fire-resistant Styrofoam waste powder is mixed with cement, steel sludge or slaked line and pearlite (S2). A mixture is made by mixing 5 wt % of the fine powder of the fire-resistant Styrofoam waste, 60 wt % of cement, 30 wt % of steel sludge and 5 wt % of pearlite or mixing 5 wt % of the fine powder of the fire-resistant Styrofoam waste, 60 wt % of cement, 30 wt % of slaked lime and 5 wt % of pearlite. Liquid soap and water are added as an adhesive to the mixture, and they are mixed for thereby preparing a compound (S3). In case that a steel sludge is added, the compound may be formed to prepare a formulated material in the form of block, bar, board, etc.(S4). In case that a slaked lime is added instead of a steel sludge, it can be used as a non-formulated material used in a plastering work or as a filler between formulated materials, in such a way to mix the same with water and to make it into a mortar form. In case of the non-formulated material made by recycling the fire-resistant Styrofoam waste prepared by mixing a slaked lime, the absorption rate of the formulated materials like conventional blocks and bricks becomes lower thanks to the inherent natures and inflammability of the Styrofoam, and at the same time, since pearlite with a condensation prevention effect is mixed, it is possible to significantly improve the condensation phenomenon which has been a long time hard-to-resolve problem in the field of building. A faster curing can be achieved after the construction with mortar since a slaked lime is mixed. Therefore, the durability and safety can be enhanced. The formulated materials recycling the fire-resistant Styrofoam waste mixed with steel sludge can be used to prepare a bar which is used for a core inserted in a fire-resistant door. Thanks to the fire-resistant performance of the fire-resistant Styrofoam made from waste, the materials formulated using the same can naturally have a fire resistant performance, and it can be injection-molded or extrusion-molded in various shapes, thus enhancing workability in the field of construction, and breakage possibility can be lowered.

In addition, a mixture of fine powder, 80 wt % of the fire-resistant Styrofoam waste and 20 wt % of pearlite is further mixed with a fire-resistant adhesive, and the mixed compound is made in a board shape, which can be used as a formulated material.

Since the fire-resistant Styrofoam heat insulator and the Styrofoam used as a noise prevention material between the floors of a building, which used to produce a lot of construction wastes when demolishing buildings, are built in a building for a long time period as they are bonded with cement or concrete as the materials of wall and floor, it needs a lot of costs when separating them from Styrofoam and cement or concrete when it is attempted to use them as recycling aggregate. In order to overcome the above mentioned problems, the fire-resistant Styrofoam wastes bonded with cement or concrete are crushed into fine powders as they are without separating Styrofoam and cement and concrete and are mixed with cement, steel sludge, slated lime, pearlite, etc. for thereby preparing formulated materials or non-formulated materials for the actual use. At this time, the mixing ratio of cement, steel sludge, slated lime, pearlite, etc. is different from the mixing ratio when being mixed with the fine powder of the waste Styrofoam.

When a building is constructed with both the formulated materials made from the fire-resistant Styrofoam wastes and the non-formulated materials made from the fire-resistant Styrofoam wastes, a synergy effect can be obtained in terms of the heat insulation and the concentration prevention through inter-supplement operations. For example, when building a wall, the bricks, which are the formulated materials, are stacked, and the non-formulated materials made from the fire-resistant Styrofoam wastes are used as an adhesive between the bricks and are plastered, and the cores, which are the formulated materials and made from the fire-resistant Styrofoam wastes, are inserted in the door frames or the window frames. In addition, so as to prevent the movements of the inserted cores, the mortar prepared by adding water to the non-formulated materials made from the fire-resistant Styrofoam wastes can be filled between the cores and the door frames or the window frames.

1. A recycled construction material made from a fire-resistant Styrofoam waste, which is made in such a way that a mixture consisting of 2 to 8 wt % of a fine powder of a fire-resistant Styrofoam waste, 50 to 70 wt % of cement, 20 to 30 wt % of a steel sludge, and 5 to 10 wt % of pearlite, a liquid soap and water are mixed, and the thusly prepared mixture is injection-molded or compression-molded.

2. A recycled construction material made from a fire-resistant Styrofoam waste, which is made in such a way that a mixture consisting of 2 to 8 wt % of a fine powder of a fire-resistant Styrofoam waste, 50 to 70 wt % of cement, 20 to 30 wt % of a slated lime, and 5 to 10 wt % of pearlite, a liquid soap and water are mixed, and the thusly prepared mixture is injection-molded or compression-molded.

3. A recycled construction material made from a fire-resistant Styrofoam waste, which is made in such a way that a mixture consisting of 60 to 80 wt % of a fine powder of a fire-resistant Styrofoam waste, 10 to 20 wt % of a steel sludge, and 10 to 20 wt % of pearlite and a fire-resistant adhesive are added and mixed, and the mixed compound are injection-molded or compression-molded in a board shape.

4. A method for preparing a recycled construction material made from a fire-resistant Styrofoam waste, comprising:
crushing a fire-resistant Styrofoam waste into a fine powder;
mixing the fine powder with cement, steel sludge, and pearlite;
preparing a compound consisting of the thusly mixed mixture and a liquid soap and water; and
preparing a formulated material by molding the compound.

5. A method for preparing a recycled construction material made from a fire-resistant Styrofoam waste, comprising:
crushing a fire-resistant Styrofoam waste bonded with cement or concrete into a fine powder;
mixing the fine powder with at least one among cement, steel sludge, slated lime, and pearlite;
preparing a compound consisting of the thusly mixed mixture and a liquid soap and water; and
preparing a formulated material by molding the compound.

6. A method for preparing a recycled construction material made from a fire-resistant Styrofoam waste, comprising:
crushing a fire-resistant Styrofoam waste into a fine powder;
mixing the fine powder with cement, slated lime, and pearlite; and
preparing a non-formulated construction material by mixing the thusly mixed mixture with a liquid soap and water.
